(19) United States
(12) Patent Application Publication
(10) Pub. No.: US 2026/0024211 A1
(43) Pub. Date: Jan. 22, 2026

(54) METHODS AND APPARATUS FOR IMAGE SEGMENTATION ON SMALL DATASETS

(71) Applicant: INTEL CORPORATION, Santa Clara, CA (US)

(72) Inventors: Xin CHEN, Los Altos, CA (US); Ke DING, Saratoga, CA (US)

(73) Assignee: INTEL CORPORATION, Santa Clara, CA (US)

(21) Appl. No.: 18/994,971

(22) PCT Filed: Sep. 29, 2022
(86) PCT No.: PCT/CN2022/122928

§ 371 Date: Jan. 15, 2025

(51) Int. Cl. G06T 7/11; G06V 10/82

(52) U.S. Cl. CPC G06T 7/11; G06V 10/82; G06T 2207/20081; G06T 2207/20084

(57) ABSTRACT

Methods, apparatus, and systems are disclosed for semantic image segmentation using small datasets. An example apparatus includes at least one memory, machine readable instructions, and processor circuitry to at least one of instantiate or execute the machine readable instructions to identify a gradient vector flow associated with the input image, generate a spatial feature map based on pixels of the input image using a two-stream neural network architecture, generate a field feature map based on the gradient vector flow using the two-stream neural network architecture, fuse the spatial feature map and the field feature map, and output a segmented image of the input image based on the fused feature map.

### FIELD OF THE DISCLOSURE

This disclosure relates generally to image data processing, and, more particularly, to methods, systems, and apparatus for image segmentation on small datasets.

### BACKGROUND

Image segmentation focuses on reducing a digital image into various subgroups (e.g., image segments) to reduce the complexity of the image to allow for further processing and/or evaluation. Image segmentation techniques can include threshold-based segmentation, edge-based segmentation, region-based segmentation, clustering-based segmentation, and/or artificial neural network-based segmentation.

### BRIEF DESCRIPTION OF THE DRAWINGS

FIG. 1 is an example environment in which image segmentation, including image segmentor circuitry, may be performed.

FIG. 2 is an example basic architecture of a UNET convolutional neural network used as part of the image segmentor circuitry of FIG. 1.

FIG. 3 is an example visualization of the relationship between gradient vector flow (GVF) and pixel motion analysis performed as part of image segmentation using the image segmentor circuitry of FIG. 1.

FIG. 4 is an example of output associated with the use of various neural networks for image segmentation of a cardiac diagnosis-based imaging dataset, including the results associated with image segmentation performed using a two-stream network of the image segmentor circuitry of FIG. 1

FIG. 5 is a block diagram of an example implementation of the image segmentor circuitry of FIG. 1.

FIG. 6 is a flowchart representative of machine-readable instructions which may be executed to implement the example image segmentor circuitry of FIG. 1 to segment image data in accordance with teachings disclosed herein.

FIG. 7 is a flowchart representative of machine-readable instructions which may be executed to implement the example image segmentor circuitry of FIG. 1 to generate spatial feature and field feature maps in accordance with teachings disclosed herein.

FIG. 8 is a flowchart representative of example machine readable instructions and/or operations that may be executed by example processor circuitry to train a neural network to determine RGB and/or gradient vector flow (GVF) weights.

FIG. 9 is a block diagram of an example processing platform structured to execute the instructions of FIG. 5 to implement the example image segmentor circuitry of FIG. 1 to perform image segmentation in accordance with teachings disclosed herein.

FIG. 10 is a block diagram of an example processing platform including processor circuitry structured to execute the example machine readable instructions and/or the example operations of FIG. 8 to implement the example first computing system of FIG. 5.

FIG. 11 is a block diagram of an example processing platform including processor circuitry structured to execute the example machine readable instructions and/or the example operations of FIG. 8 to implement the example second computing system of FIG. 5.

FIG. 12 is a block diagram of an example implementation of the processor circuitry of FIGS. 9, 10 and/or 11.

FIG. 13 is a block diagram of another example implementation of the processor circuitry of FIGS. 9, 10 and/or 11.

FIG. 14 is a block diagram of an example software distribution platform (e.g., one or more servers) to distribute software (e.g., software corresponding to the example machine readable instructions of FIGS. 6, 7, and/or 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for case of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Semantic image segmentation is a highly relevant task in visual inspection systems, medical image analyses, robotic perception, and/or image compression. For example, image segmentation can be used to partition an image into multiple segments. In some examples, image segmentation is regarded as an integral component in digital image processing used for dividing the image into different segments and/or discrete regions. Advances in image segmentation can be attributed to deeper and larger Convolutional Neural Networks (CNNs) models which can be used to learn a hierarchical representation of input data. However, training deeper and larger CNN models demands high quality and/or large-scale training datasets, without which problems associated with overfitting can occur. Furthermore, some applications, such as medical image analyses and/or defect inspect systems can be difficult to build large-scale datasets for due to the imaging data being acquired by dedicated sensors. For example, compared to images in the wild, data acquired by dedicated sensors is rare, making such data acquisition expensive (e.g., finding wafer-based defects using the E-Beam wafer defect inspection system). Using datasets that are expensive to acquire results in increased expenses associated with building large-scale training datasets. As a consequence, segmentation performed using CNNs that are trained on smaller datasets is lower in accuracy as compared to segmentation performed based on training using large-scale datasets (e.g., when using natural images, etc.).

In some examples, transfer learning can be used to allow for the training of deeper models with smaller datasets. Transfer learning is a machine learning method where a model developed for a task is reused as the starting point for a model on a second task. For example, transfer learning can be used in deep learning to implement pre-trained models as a starting point on computer vision and/or natural language processing tasks given the large number of resources (e.g., compute and/or time-based resources) needed to develop neural network models on such tasks. In some examples, pre-trained models (e.g., VGG16, Resnet50 models trained on ImageNet) can be widely used in a backbone of the image segmentation task. However, since such deeper models are trained on ImageNet (e.g., in which the images are all natural images), the properties of such images differ from the data acquired by dedicated imaging systems.

Methods and apparatus for image segmentation on small datasets are disclosed herein. For example, a two-stream UNET architecture can be used for image segmentation with a small dataset. In examples disclosed herein, the UNET architecture is a encode-decode CNN model used to generate spatial feature map(s) and/or field feature map(s) for automatic segmentation given an input image. In examples disclosed herein, the two-stream network includes a spatial stream (e.g., associated with the generation of a spatial feature map) and the other is referred to as vector stream (e.g., associated with the generation of a field feature map). For example, an input of the spatial stream can include an intensity value of the pixels (e.g., either RGB or grayscale-level) and the input of the vector field can include a gradient vector flow (GVF), given that GVF is considered as one of best low-level pixel-wise features and greatly improves original active contour models acting as an external force. In examples disclosed herein, the spatial feature map and the field feature map are fused to generate an image segmentation output.

Although examples disclosed herein are discussed in connection with image segmentation, disclosed examples apply to image analysis more generally. Thus, although examples disclosed herein refer to, for instance, a UNET-based architecture, examples disclosed herein more generally apply to a neural network architecture. Examples disclosed herein apply to, for instance, any other type of image segmentation task and/or image analysis task.

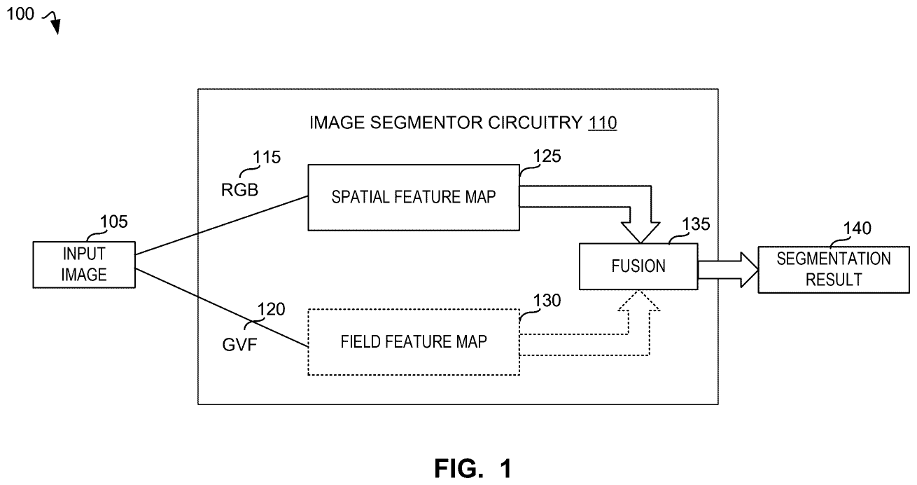

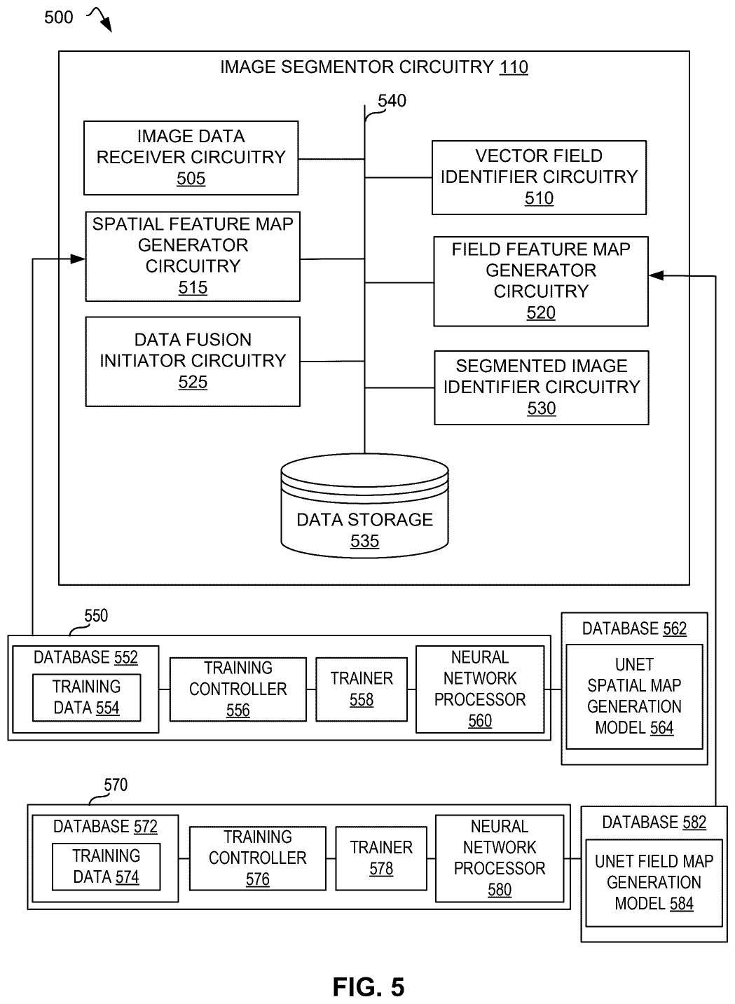

FIG. 1 is an example environment 100 in which image segmentation, including example image segmentor circuitry 110, may be performed. In the example of FIG. 1, the environment 100 includes an input image 105. The features of the input image 105 can include example pixel intensity value(s) 115 (e.g., either RGB or grayscale-level) and an example gradient vector flow (GVF) 120. In the example of FIG. 1, the pixel intensity value(s) 115 and the GVF 120 can serve as input into a UNET architecture of the image segmentor circuitry 110 to generate a spatial feature map 125 and/or a field feature map 130, as described in more detail in connection with FIG. 5. In some examples, the image segmentor circuitry 110 generates a spatial feature map 125 using the pixel intensity value(s) 115 by applying filter(s) and/or feature detector(s) to the input image or the feature map output of the prior neural network layers (e.g., associated with the UNET CNN architecture). In some examples, the image segmentor circuitry 110 generates a field feature map 130 using the GVF 120, as described in more detail in connection with FIG. 5. For example, the GVF 120 represents a vector field that is produced by a process that smooths and diffuses an input vector field, creating a vector field from images that points to object edges from a distance. For example, during the process of image segmentation, the location of object edges can assist in segmenting objects using active contours attracted to edges. In the example of FIG. 1, the image segmentor circuitry 110 fuses the spatial feature map 125 and the field feature map 130 using a fusion step 135 to obtain the final image segmentation result 140.

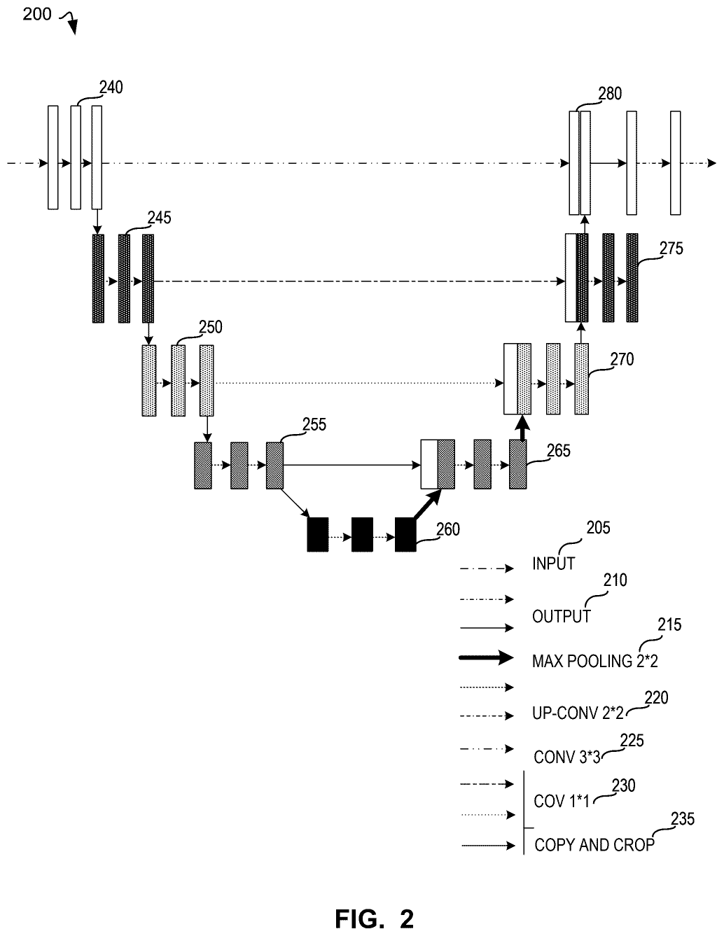

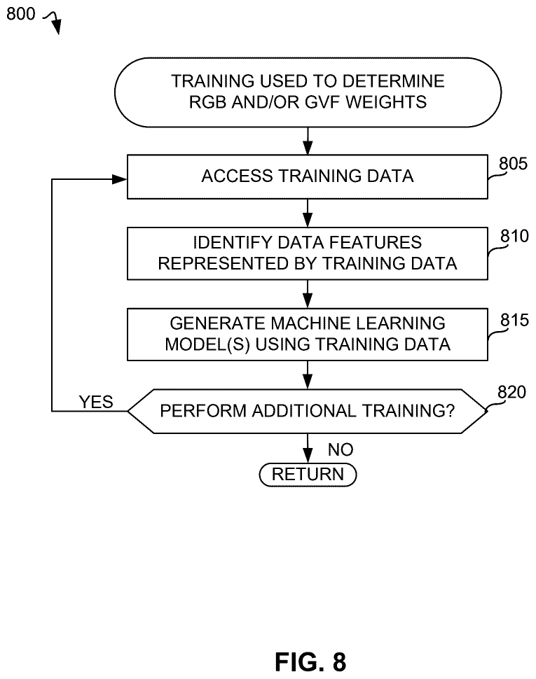

In the example of FIG. 1, the backbone of each stream (e.g., a spatial stream and a vector stream) of the two-stream UNET architecture for image segmentation using small datasets is a basic UNET model described in more detail in connection with FIG. 2. For example, spatial feature and field feature maps 125, 130 are generated by each of the UNET-based architectures, where the spatial feature map 125 is generated by a CNN with a basic UNET architecture using RGB values for images as input, with weights of the RGB stream learned during training, as described in more detail in connection with FIGS. 5 and 8. Furthermore, the field feature map 130 can be generated by another CNN with a basic UNET architecture where GVF values of the input image 105 serve as an input, with weights of the GVF stream learned during training, as described in more detail in connection with FIGS. 5 and 8. In particular, the two-stream network shown in the example of FIG. 1 can be applied in applications associated with action recognition in videos. In some examples, the two-stream network can be associated with a human-based visual cortex, which includes a ventral stream and a dorsal stream. For example, much like the two-stream network, the ventral stream reasons about object identity (e.g., object recognition) while the dorsal stream reasons about spatial relationships without regard for semantics (e.g., motion analysis).

FIG. 2 is an example basic architecture 200 of a UNET convolutional neural network used as part of the image segmentor circuitry 110 of FIG. 1. In particular, the UNET architecture 200 allows for the segmentation of images of specific sizes (e.g., 512×512) that can be computed within a short timeframe using a graphics processing unit (GPU). For example, the UNET architecture 200 uses the concept of fully convolutional networks, capturing both the features of the context as well as the localization. For example, the UNET architecture 200 uses successive contracting layers, which are immediately followed by up-sampling operators for achieving higher resolution outputs on the input images. As shown in the example of FIG. 2, the UNET architecture is a U-shaped structure that forms a fully convolutional network, with an initial contracting path followed by an expanding path. For example, the flow of the image processing through the architecture 200 can be represented using various operations, including an input 205, an output 210, pooling 215 (e.g., max pooling 2*2), up convolution 220 (e.g., up-conv 2*2), convolutions 225, 230 (e.g., conv 3*3, conv 1*1, etc.), and a copy and crop processing step 235. In the example of FIG. 2, the architecture 200 includes operations associated with an input image being passed through the model, starting with an input image tile 240, followed by convolutional layers with a Rectified Linear Unit (ReLU) activation function. The architecture 200 includes multi-channel feature maps 245, 250, 255, 260, 265, 270, 275 with various numbers of channels associated with each of the feature maps. For example, the image size can be reduced (e.g., from 572×572 to 568×568) using convolutions that reduce overall dimensionality. Additionally, the architecture 200 can include an encoder block (e.g., to achieve a constant reduction of image size using max pooling layers and an increasing number of filters present in the encoder architecture) and a decoder block (e.g., including a decreasing number of filters with a gradual up-sampling in the layers). Additionally, the architecture 200 includes skip connections to preserve any loss from previous layers and permit faster model convergence, resulting in a final output segmentation map 245.

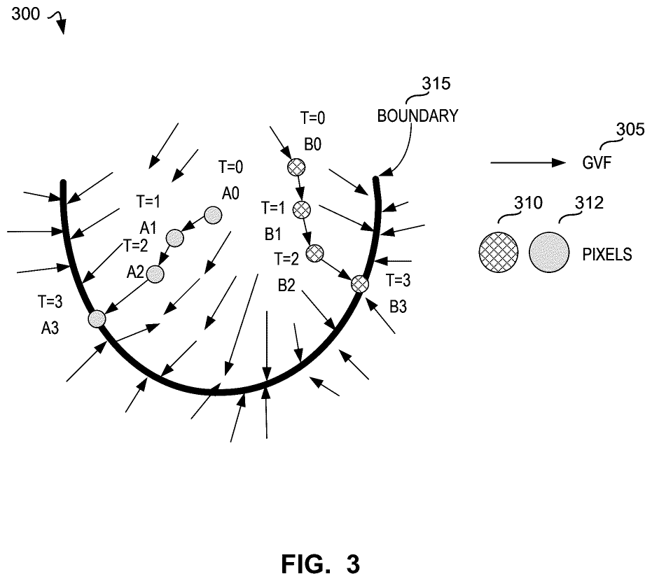

FIG. 3 is an example visualization 300 of the relationship between gradient vector flow (GVF) 305 and motion analysis associated with pixel(s) 310, 312 performed as part of image segmentation using the image segmentor circuitry 110 of FIG. 1. In the example of FIG. 3, each pixel 310, 312 of an image can be considered as a component of an object, with pixel-based motion patterns associated with forces that push the objects along a direction of a given force. For example, pixels 310, 312 can move from a current position to a boundary 315 of the object step-by-step under the GVF 305. In particular, the goal of image segmentation is to identify boundaries of the objects. As such, GVF-based patterns can represent how components move to the boundary 315 of a given object, such that features from the GVF patterns can be used to infer boundaries in a given input image. As described in connection with FIG. 1, the field feature map 130 includes temporal information that can be used for tracking pixel 310, 312 movement. For example, pixel motion can be tracked over time (e.g., t=1, t=2, etc.) for different pixel(s) 310, 312 identified in the input image 105 (e.g., a0, a2, a3, etc.). For example, a first pixel 310 can move in the following order: a0→a1→a2→a3 at time t=0, t=1, t=2, t=3, respectively, while a second pixel 312 can move from b0→b1→b2→b3 at time t=0, t=1, t=2, t=3, respectively.

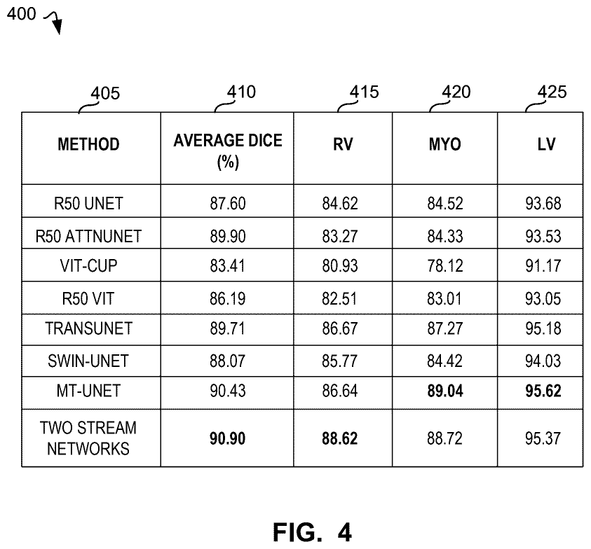

FIG. 4 is an example of output 400 associated with the use of various neural networks for image segmentation of a cardiac diagnosis-based imaging dataset, including the results associated with image segmentation performed using a two-stream network of the image segmentor circuitry 110 of FIG. 1. In the example of FIG. 4, methods and apparatus disclosed herein can be used to perform image segmentation associated with an automated cardiac diagnosis dataset. For example, magnetic resonance imaging (MRI) datasets captured from different patients can be used as part of image segmentation performance testing. For example, each patient scan can be annotated with ground truth labels for a left ventricle (LV), right ventricle (RV), and/or myocardium (MYO). Various example methods of image segmentation 405 (e.g., R50 UNET, R50 AttnUNET, VIT-CUP, R50 VIT, TransUNET, Dwin-UNET, MT-UNET, etc.) can be compared to a two-stream network-based image segmentation method disclosed in the examples described herein. For example, the image segmentation of cardiac-based datasets can be assessed using a measure of a Dice similarity coefficient (e.g., average Dice percentage 410). The Dice similarity coefficient is a spatial overlap index and a reproducibility validation metric that can be used to evaluate a segmentation model. The Dice coefficient can represent a measure of an overlap between two masks (e.g., true mask versus predicted mask), where 1 indicates a perfect overlap while 0 indicates no overlap. For example, a mask corresponds to a classification of image pixels as either 1 or 0, where 1 corresponds to a presence of the mask and 0 corresponds to an absence of the mask. Such masking permits identification of specific region(s) and/or object(s) of an image. As such, a true mask corresponds to an accurate and/or verified representation of the region's and/or object's locations, whereas a predicted mask corresponds to the predicted location of the region and/or object. In examples disclosed herein, the predicted mask corresponds to an area where a cardiac region is predicted to be based on image segmentation, whereas the true mask corresponds to a cardiac region that has been verified to include the region of interest (e.g., right ventricle, etc.) As such, prediction accuracy can be determined by comparing the true mask with the predicted mask (e.g., where greater alignment of the true mask and the predicted mask indicates greater prediction accuracy). In the example of FIG. 4, Dice similarity coefficients are included for various cardiac regions (e.g., RV 415, MYO 420, LV 425), with a higher overall average Dice coefficient (90.90%) shown when using the two-stream network image segmentation method disclosed herein as compared to other existing image segmentation techniques.

FIG. 5 is a block diagram of an example implementation of the image segmentor circuitry 110 of FIG. 1. The image segmentor circuitry 110 of FIG. 5 may be instantiated (e.g., creating an instance of, bring into being for any length of time, materialize, implement, etc.) by processor circuitry such as a central processing unit executing instructions. Additionally or alternatively, the image segmentor circuitry 110 of FIG. 5 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 5 may, thus, be instantiated at the same or different times. Some or all of the circuitry may be instantiated, for example, in one or more threads executing concurrently on hardware and/or in series on hardware. Moreover, in some examples, some or all of the circuitry of FIG. 5 may be implemented by microprocessor circuitry executing instructions to implement one or more virtual machines and/or containers.

In the illustrated example, the image segmentor circuitry 110 includes image data receiver circuitry 505, vector field identifier circuitry 510, spatial feature map generator circuitry 515, field feature map generator circuitry 520, data fusion initiator circuitry 525, segmented image identifier circuitry 530, and a data storage 535. In some examples, the data storage 525 is external to the image segmentor circuitry 110 in a location accessible to the image segmentor circuitry 110. In the example of FIG. 5, the image data receiver circuitry 505, the vector field identifier circuitry 510, the spatial feature map generator circuitry 515, the field feature map generator circuitry 520, the data fusion initiator circuitry 525, the segmented image identifier circuitry 530, and/or the data storage 535 are in communication using an example bus 540.

The image data receiver circuitry 505 receives image data based on the input image 105 of FIG. 1. For example, the image data receiver circuitry 505 identifies image-based information such as pixel intensity value(s) 115 (e.g., either RGB or grayscale-level). In some examples, image data receiver circuitry 505 identifies a size of the input image 105. For example, in image segmentation, the input image 105 can be partitioned into multiple segments to simplify a representation of the image and reduce the complexity of image analysis (e.g., identification of objects within the image, etc.). In some examples, a label can be assigned to every pixel in the input image 105 such that pixels with the same label can be characterized as sharing certain characteristics.

The vector field identifier circuitry 510 identifies the gradient vector flow (GVF) 120 associated with the input image 105. For example, the GVF 120 represents a vector diffusion-based model that can be used for calculating the image gradient in a specified direction. In some examples, GVF can be used to spread the gradient vector from the object boundary to the rest of the image. As described in connection with FIG. 3, GVF-based patterns can represent how components move to the boundary 315 of FIG. 3 of a given object, such that features from the GVF patterns can be used to infer boundaries in the input image 105.

The spatial feature map generator circuitry 515 generates the spatial feature map 125 of FIG. 1. For example, the spatial feature map generator circuitry 515 includes the spatial stream (e.g., associated with the generation of a spatial feature map) as part of the two-stream network of FIG. 1. For example, the spatial feature map generator circuitry 515 generates the spatial feature map 125 using the UNET convolutional neural network architecture described in connection with FIG. 2. The input of the spatial stream can include an intensity value of the pixels (e.g., cither RGB or grayscale-level) identified using the image data receiver circuitry 505. For example, the spatial feature map generator circuitry 515 generates the spatial feature map 125 using RGB values for images as input, with weights of the RGB stream learned during training. For example, the spatial feature map generator circuitry 515 executes neural network model(s) to determine weights associated with the RGB stream.

While in the example of FIG. 5 the spatial feature map generator circuitry 515 executes a neural network model, the spatial feature map generator circuitry 515 can use other types of neural network model(s) to identify weights associated with the RGB stream that are used to generate the spatial feature map 125 of FIG. 1. As shown in FIG. 5, a first computing system 550 trains a neural network to generate a UNET spatial map generation model based on training data associated with RGB value input(s). The example first computing system 550 can include a neural network processor 560. In examples disclosed herein, the neural network processor 560 implements a neural network. The example first computing system 550 of FIG. 5 includes a neural network trainer 558. The example neural network trainer 558 of FIG. 5 performs training of the neural network implemented by the neural network processor 560. The example first computing system 550 of FIG. 3 includes a training controller 556. The training controller 556 instructs the neural network trainer 558 to perform training of the neural network based on training data 554. In the example of FIG. 5, the training data 554 used by the neural network trainer 558 to train the neural network is stored in a database 552. The example database 552 of the illustrated example of FIG. 5 is implemented by any memory, storage device and/or storage disc for storing data such as, for example, flash memory, magnetic media, optical media, etc. Furthermore, the data stored in the example database 552 may be in any data format such as, for example, binary data, comma delimited data, tab delimited data, structured query language (SQL) structures, image data, etc. While the illustrated example database 552 is illustrated as a single element, the database 552 and/or any other data storage elements described herein may be implemented by any number and/or type(s) of memories.

In the example of FIG. 5, the training data 554 can include data representative of the input image 105 (e.g., RGB values). The neural network trainer 558 can train the neural network implemented by the neural network processor 560 using the training data 554. Based on the RGB values in the training data 554, the neural network trainer 558 trains the neural network to identify RGB weights associated with image data received by the image segmentor circuitry 110. UNET spatial map generation model(s) 564 are generated as a result of the neural network training. The UNET spatial map generation model(s) 564 are stored in a database 562. The databases 552, 562 may be the same storage device or different storage devices. The spatial feature map generator circuitry 515 executes the UNET spatial map generation model(s) 564 to generate the spatial feature map 125 of FIG. 1.

The field feature map generator circuitry 520 generates the field feature map 130 of FIG. 1. For example, the field feature map generator circuitry 520 includes the vector stream (e.g., associated with the generation of a field feature map) as part of the two-stream network of FIG. 1. For example, the field feature map generator circuitry 520 generates the field feature map 130 using the UNET convolutional neural network architecture described in connection with FIG. 2. The input of the vector stream can include the GVF identified using the vector field identifier circuitry 510. For example, the field feature map generator circuitry 520 generates the field feature map 130 using GVF values for images as input, with weights of the GVF stream learned during training. For example, the field feature map generator circuitry 520 executes neural network model(s) to determine weights associated with the GVF stream.

While in the example of FIG. 5 the field feature map generator circuitry 520 executes a neural network model, the field feature map generator circuitry 520 can use other types of neural network model(s) to identify weights associated with the GVF stream that are used to generate the field feature map 130 of FIG. 1. As shown in FIG. 5, a second computing system 570 trains a neural network to generate a UNET field map generation model based on training data associated with GVF input(s). The example second computing system 570 can include a neural network processor 580. In examples disclosed herein, the neural network processor 580 implements a neural network. The example second computing system 570 of FIG. 5 includes a neural network trainer 578. The example neural network trainer 578 of FIG. 5 performs training of the neural network implemented by the neural network processor 580. The example second computing system 570 of FIG. 5 includes a training controller 576. The training controller 576 instructs the neural network trainer 578 to perform training of the neural network based on training data 574. In the example of FIG. 5, the training data 574 used by the neural network trainer 578 to train the neural network is stored in a database 572. The example database 572 of the illustrated example of FIG. 5 is implemented by any memory, storage device and/or storage disc for storing data such as, for example, flash memory, magnetic media, optical media, etc. Furthermore, the data stored in the example database 572 may be in any data format such as, for example, binary data, comma delimited data, tab delimited data, structured query language (SQL) structures, image data, etc. While the illustrated example database 572 is illustrated as a single element, the database 572 and/or any other data storage elements described herein may be implemented by any number and/or type(s) of memories.

In the example of FIG. 5, the training data 574 can include data representative of the input image 105 (e.g., GVFs). The neural network trainer 578 can train the neural network implemented by the neural network processor 580 using the training data 574. Based on the GVFs in the training data 574, the neural network trainer 578 trains the neural network to identify GVF weights associated with image data received by the image segmentor circuitry 110. UNET field map generation model(s) 584 are generated as a result of the neural network training. The UNET field map generation model(s) 584 are stored in a database 582. The databases 572, 582 may be the same storage device or different storage devices. The field feature map generator circuitry 520 executes the UNET field map generation model(s) 584 to generate the field feature map 130 of FIG. 1.

The data fusion initiator circuitry 525 fuses the spatial feature map 125 generated using the spatial feature map generator circuitry 515 with the field feature map 130 generated using the field feature map generator circuitry 520. For example, the UNET architecture used to generate the spatial feature map 125 and/or the field feature map 130 can be based on the basic UNET architecture 200 shown in connection with FIG. 2. In some examples, the UNET architecture used can exclude the last output layer of the basic UNET and instead be developed as a spatial and/or vector field feature extractor. For example, the UNET architecture has a total of 23 convolutional layers including a final convolutional layer with a 1×1 convolution. In examples disclosed herein, both steams in the architecture have 22 convolutional layers and 64 output channels, with a kernel size of the spatial and/or vector field feature extractors being 3×3 with a stride of one. The data fusion initiator circuitry 525 fuses the spatial feature map and the field feature map, where the output fusion layer is a mask of the segmentation results. In some examples, the data fusion initiator circuitry 525 can perform fusion using at least one of a sum fusion, a matrix fusion, a concatenation fusion, and/or a convolution fusion.

The segmented image identifier circuitry 530 outputs image segmentation results based on the data fusion initiator circuitry 525 output. For example, the segmented image identifier circuitry 530 can output a mask associated with the image segmentation. In some examples, the segmented image identifier circuitry 530 identifies the accuracy of the obtained results by comparing the output mask with a true mask. In some examples, the segmented image identifier circuitry 530 outputs data associated with various areas of the original input image 105 of FIG. 1, such as a classification of the areas and/or objects within the image based on the segmentation results (e.g., left ventricle, right ventricle, myocardium identification using cardiac data, as described in connection with FIG. 4).

The data storage 535 can be used to store any information associated with the image data receiver circuitry 505, the vector field identifier circuitry 510, the spatial feature map generator circuitry 515, the field feature map generator circuitry 520, the data fusion initiator circuitry 525, the segmented image identifier circuitry 530. The example data storage 535 of the illustrated example of FIG. 5 can be implemented by any memory, storage device and/or storage disc for storing data such as flash memory, magnetic media, optical media, etc. Furthermore, the data stored in the example data storage 535 can be in any data format such as binary data, comma delimited data, tab delimited data, structured query language (SQL) structures, image data, etc.

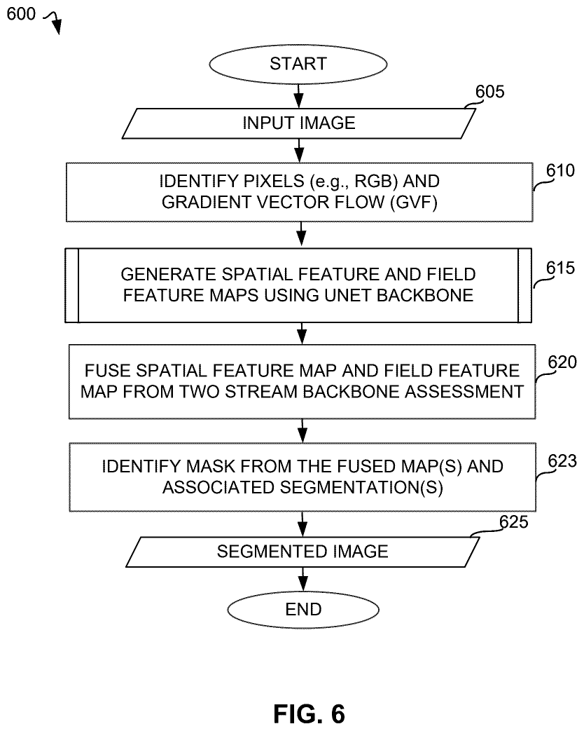

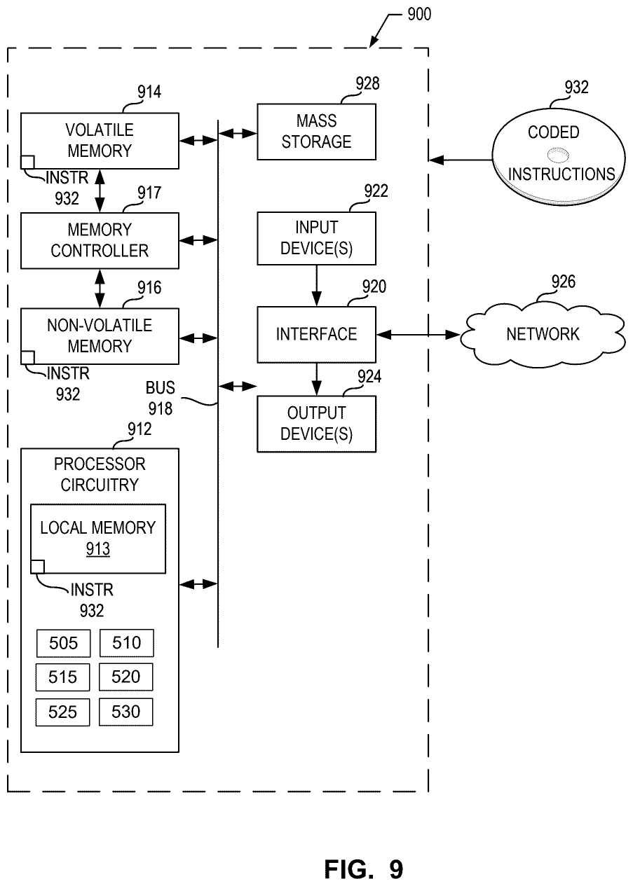

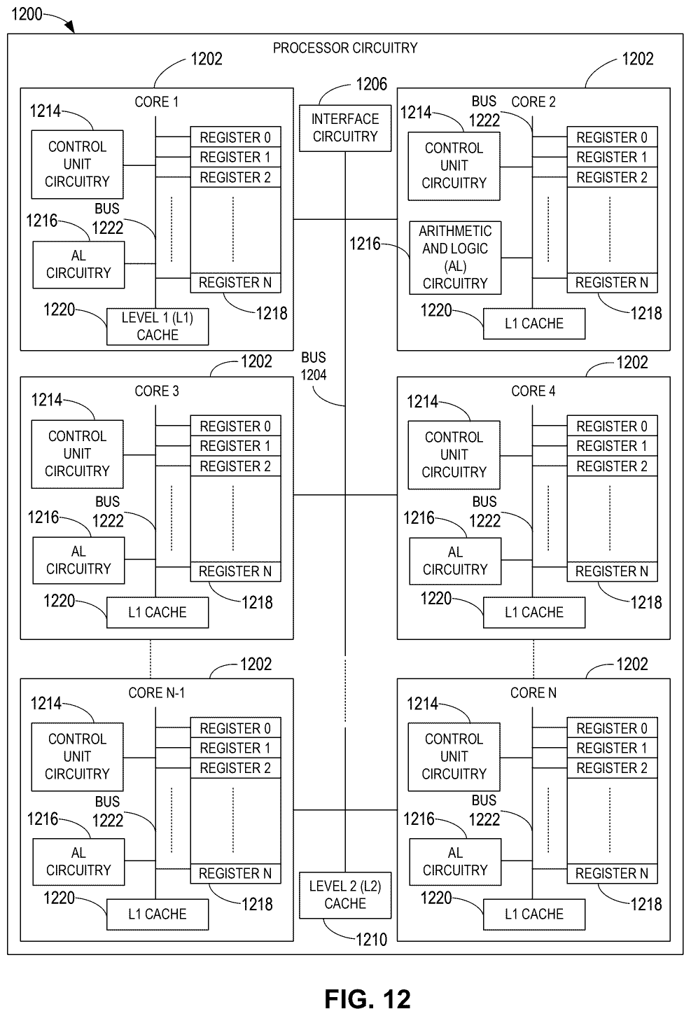

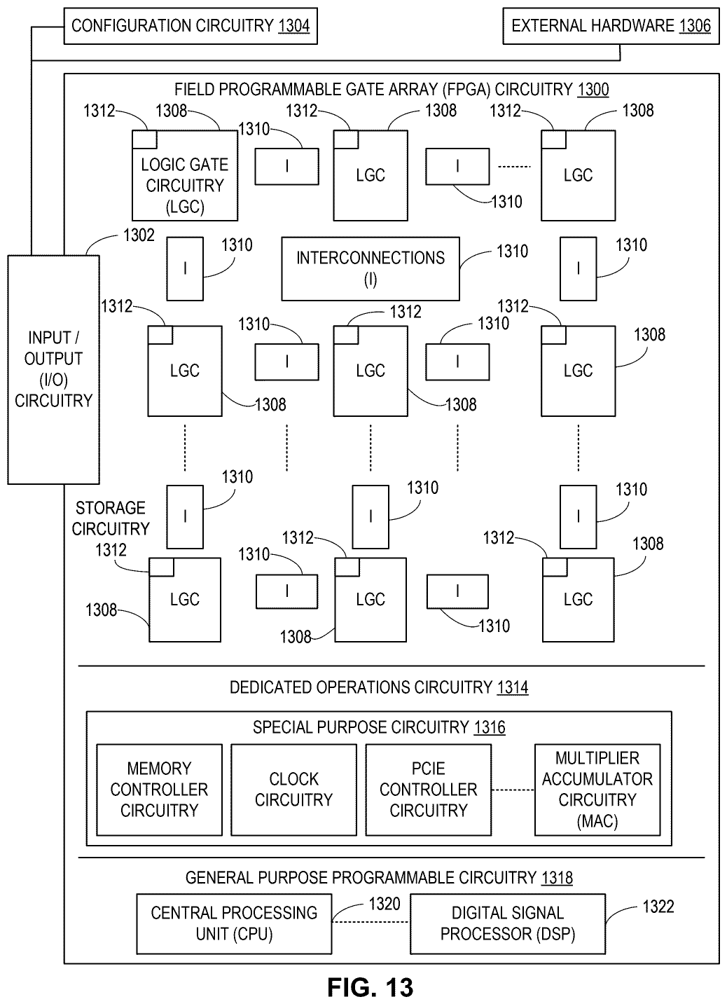

In some examples, the apparatus includes means receiving image data. For example, the means for receiving image data may be implemented by image data receiver circuitry 505. In some examples, the image data receiver circuitry 505 may be instantiated by processor circuitry such as the example processor circuitry 912 of FIG. 9. For instance, the image data receiver circuitry 505 may be instantiated by the example microprocessor 1200 of FIG. 12 executing machine executable instructions such as those implemented by at least block 610 of FIG. 6. In some examples, the image data receiver circuitry 505 may be instantiated by hardware logic circuitry, which may be implemented by an ASIC, XPU, or the FPGA circuitry 1300 of FIG. 13 structured to perform operations corresponding to the machine readable instructions. Additionally or alternatively, the image data receiver circuitry 505 may be instantiated by any other combination of hardware, software, and/or firmware. For example, the image data receiver circuitry 505 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a vector field. For example, the means for identifying a vector field may be implemented by vector field identifier circuitry 510. In some examples, the vector field identifier circuitry 510 may be instantiated by processor circuitry such as the example processor circuitry 912 of FIG. 9. For instance, the vector field identifier circuitry 510 may be instantiated by the example microprocessor 1200 of FIG. 12 executing machine executable instructions such as those implemented by at least block 610 of FIG. 6. In some examples, the vector field identifier circuitry 510 may be instantiated by hardware logic circuitry, which may be implemented by an ASIC, XPU, or the FPGA circuitry 1300 of FIG. 13 structured to perform operations corresponding to the machine readable instructions. Additionally or alternatively, the vector field identifier circuitry 510 may be instantiated by any other combination of hardware, software, and/or firmware. For example, the vector field identifier circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

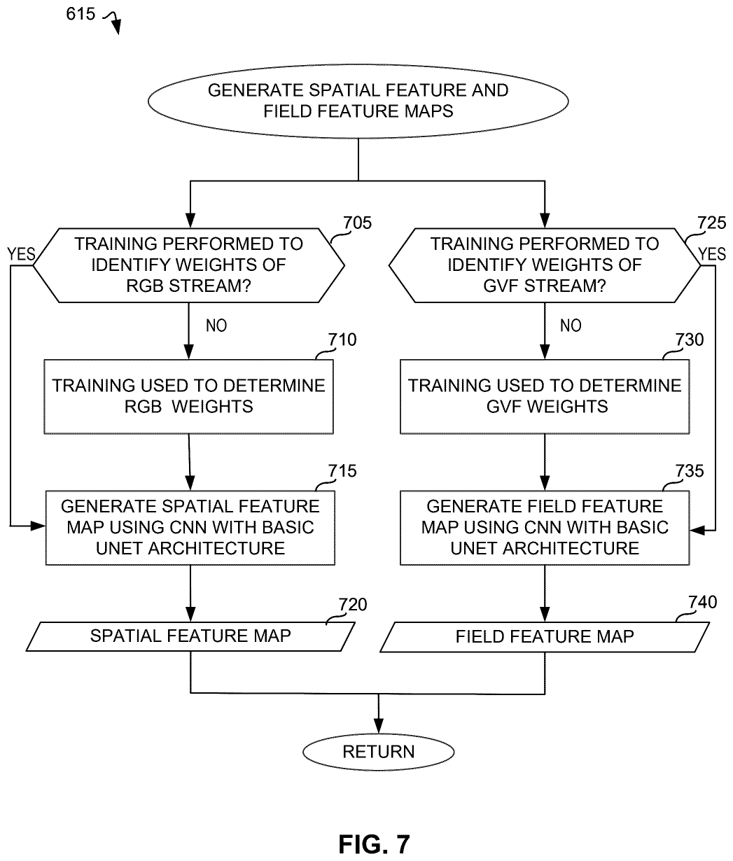

In some examples, the apparatus includes means for generating a spatial feature map. For example, the means for generating a spatial feature map may be implemented by spatial feature map generator circuitry 515. In some examples, the spatial feature map generator circuitry 515 may be instantiated by processor circuitry such as the example processor circuitry 912 of FIG. 9. For instance, the spatial feature map generator circuitry 515 may be instantiated by the example microprocessor 1200 of FIG. 12 executing machine executable instructions such as those implemented by at least block 715 of FIG. 7. In some examples, the spatial feature map generator circuitry 515 may be instantiated by hardware logic circuitry, which may be implemented by an ASIC, XPU, or the FPGA circuitry 1300 of FIG. 13 structured to perform operations corresponding to the machine readable instructions. Additionally or alternatively, the spatial feature map generator circuitry 515 may be instantiated by any other combination of hardware, software, and/or firmware. For example, the spatial feature map generator circuitry 515 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating a field feature map. For example, the means for generating a field feature map may be implemented by a field feature map generator circuitry 520. In some examples, the field feature map generator circuitry 520 may be instantiated by processor circuitry such as the example processor circuitry 912 of FIG. 9. For instance, the field feature map generator circuitry 520 may be instantiated by the example microprocessor 1200 of FIG. 12 executing machine executable instructions such as those implemented by at least block 735 of FIG. 7. In some examples, the field feature map generator circuitry 520 may be instantiated by hardware logic circuitry, which may be implemented by an ASIC, XPU, or the FPGA circuitry 1300 of FIG. 13 structured to perform operations corresponding to the machine readable instructions. Additionally or alternatively, the field feature map generator circuitry 520 may be instantiated by any other combination of hardware, software, and/or firmware. For example, the field feature map generator circuitry 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for fusing data. For example, the means for fusing data may be implemented by data fusion initiator circuitry 525. In some examples, the data fusion initiator circuitry 525 may be instantiated by processor circuitry such as the example processor circuitry 912 of FIG. 9. For instance, the data fusion initiator circuitry 525 may be instantiated by the example microprocessor 1200 of FIG. 12 executing machine executable instructions such as those implemented by at least block 620 of FIG. 6. In some examples, the data fusion initiator circuitry 525 may be instantiated by hardware logic circuitry, which may be implemented by an ASIC, XPU, or the FPGA circuitry 1300 of FIG. 13 structured to perform operations corresponding to the machine readable instructions. Additionally or alternatively, the data fusion initiator circuitry 525 may be instantiated by any other combination of hardware, software, and/or firmware. For example, the data fusion initiator circuitry 525 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying a segmented image. For example, the means for identifying a segmented image may be implemented by segmented image identifier circuitry 530. In some examples, the segmented image identifier circuitry 530 may be instantiated by processor circuitry such as the example processor circuitry 912 of FIG. 9. For instance, the segmented image identifier circuitry 530 may be instantiated by the example microprocessor 1200 of FIG. 12 executing machine executable instructions such as those implemented by at least block 623 of FIG. 6. In some examples, the segmented image identifier circuitry 530 may be instantiated by hardware logic circuitry, which may be implemented by an ASIC, XPU, or the FPGA circuitry 1300 of FIG. 13 structured to perform operations corresponding to the machine readable instructions. Additionally or alternatively, the segmented image identifier circuitry 530 may be instantiated by any other combination of hardware, software, and/or firmware. For example, the segmented image identifier circuitry 530 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the image segmentor circuitry 110 of FIG. 1 is illustrated in FIG. 5, one or more of the elements, processes and/or devices illustrated in FIG. 5 may be combined, divided, re-arranged, omitted, eliminated and/or implemented in any other way. Further, the example image data receiver circuitry 505, example vector field identifier circuitry 510, example spatial feature map generator circuitry 515, example field feature map generator circuitry 520, example data fusion initiator circuitry 525, example segmented image identifier circuitry 530, and/or, more generally, the example image segmentor circuitry 110 of FIG. 1 may be implemented by hardware, software, firmware and/or any combination of hardware, software and/or firmware. Thus, for example, any of the image data receiver circuitry 505, vector field identifier circuitry 510, spatial feature map generator circuitry 515, field feature map generator circuitry 520, data fusion initiator circuitry 525, segmented image identifier circuitry 530 and/or, more generally, the example image segmentor circuitry 110 of FIG. 1 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example image segmentor circuitry 110 of FIG. 1 may include one or more elements, processes, and/or devices in addition to, or instead of, those illustrated in FIG. 5, and/or may include more than one of any or all of the illustrated elements, processes and devices.

While an example manner of implementing the first computing system 550 is illustrated in FIG. 5, one or more of the elements, processes and/or devices illustrated in FIG. 5 may be combined, divided, re-arranged, omitted, eliminated and/or implemented in any other way. Further, the example neural network processor 560, the example trainer 558, the example training controller 556, the example database(s) 552, 562 and/or, more generally, the example first computing system 550 of FIG. 3 may be implemented by hardware, software, firmware and/or any combination of hardware, software and/or firmware. Thus, for example, any of the neural network processor 560, the example trainer 558, the example training controller 556, the example database(s) 552, 562 and/or, more generally, the example first computing system 550 of FIG. 5 could be implemented by could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example first computing system 550 of FIG. 5 may include one or more elements, processes and/or devices in addition to, or instead of, those illustrated in FIG. 5, and/or may include more than one of any or all of the illustrated elements, processes and devices.

While an example manner of implementing the second computing system 570 is illustrated in FIG. 5, one or more of the elements, processes and/or devices illustrated in FIG. 5 may be combined, divided, re-arranged, omitted, eliminated and/or implemented in any other way. Further, the example neural network processor 580, the example trainer 578, the example training controller 576, the example database(s) 572, 582 and/or, more generally, the example second computing system 570 of FIG. 5 may be implemented by hardware, software, firmware and/or any combination of hardware, software and/or firmware. Thus, for example, any of the neural network processor 580, the example trainer 578, the example training controller 576, the example database(s) 572, 582 and/or, more generally, the example second computing system 570 of FIG. 5 could be implemented by could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example second computing system 570 of FIG. 5 may include one or more elements, processes and/or devices in addition to, or instead of, those illustrated in FIG. 5, and/or may include more than one of any or all of the illustrated elements, processes and devices.

Flowcharts representative of example machine readable instructions, which may be executed to configure processor circuitry to implement the image segmentor circuitry 110 of FIG. 1 are shown in FIGS. 6-8. The machine readable instructions may be one or more executable programs or portion(s) of an executable program for execution by processor circuitry, such as the processor circuitry 912, 1012, 1112 shown in the example processor platform 900, 1000, 1100 discussed below in connection with FIGS. 9, 10, 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIG. 6-8, many other methods of implementing the example image segmentor circuitry 110 of FIG. 1 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine-readable instructions and/or operations 600 which may be executed and/or instantiated by processor circuitry to implement the example image segmentor circuitry 110 of FIG. 1. The machine readable instructions and/or the operations 600 of FIG. 6 begin at block 605 at which the image data receiver circuitry 505 receives the input image 105 of FIG. 1. In the example of FIG. 6, the image data receiver circuitry 505 identifies image-based information such as pixel intensity value(s) 115 (e.g., either RGB or grayscale-level), while the vector field identifier circuitry 510 identifies the gradient vector flow (GVF) 120 associated with the input image 105 (block 610). The spatial feature map generator circuitry 515 and the field feature generator circuitry 520 generate the spatial feature map 125 of FIG. 1 and the field feature map 130 of FIG. 1, respectively, as described in more detail in connection with FIG. 7 (block 615). For example, the spatial feature map generator circuitry 515 and the field feature generator circuitry 520 generate the map(s) 125, 130 based on the identified pixels (e.g., RGB data) and/or gradient vector flow data of the input image 105, which serve as inputs into a two-stream neural network (e.g., based on a UNET architecture). In the example of FIG. 6, the data fusion initiator circuitry 525 fuses the resulting spatial feature map and field feature map (block 620). The segmented image identifier circuitry 530 identifies a mask of the segmentation results based on the output of the data fusion initiator circuitry 525 (block 623). The image segmentor circuitry 110 outputs the segmented image and/or the mask identified as part of the image segmentation, including specific regions of interest (e.g., left ventricle, right ventricles of a cardiac image dataset).

FIG. 7 is a flowchart representative of example machine-readable instructions and/or operations 615 which may be executed and/or instantiated by processor circuitry to implement the example image segmentor circuitry 110 of FIG. 1. The machine readable instructions and/or the operations 615 of FIG. 7 begin at block 705 at which the spatial feature map generator circuitry 515 determines whether training of the convolutional neural network associated with the UNET architecture 200 of FIG. 2 is needed to identify weights associated with the RGB stream, or the spatial stream (block 705). If training is needed, the spatial feature map generator circuitry 515 initiates training of the neural network, as described in connection with FIG. 8 (block 710). If training is completed, the spatial feature map generator circuitry 515 generates the spatial feature map 125 using the trained neural network (block 715). The spatial feature map 125 output represents an output generated using the spatial stream of the two-stream neural network (block 720). The field feature generator circuitry 520 generates a field feature map in conjunction with the generation of the spatial feature map as part of the two-stream network. For example, the field feature generator circuitry 520 determines whether training is needed to identify associated with the GVF stream, or the temporal stream (block 725). If training is needed, the field feature generator circuitry 520 initiates training of the neural network, as described in connection with FIG. 8 (block 730). If training is completed, field feature generator circuitry 520 generates the field feature map 130 using the trained neural network (block 735). The field feature map 130 output represents an output generated using the temporal stream of the two-stream neural network (block 740).

FIG. 8 is a flowchart representative of example machine readable instructions and/or operations 800 that may be executed and/or instantiated by example processor circuitry to train a neural network to determine RGB and/or gradient vector flow (GVF) weights. For example, FIG. 8 is representative of example machine readable instructions which may be executed to implement elements of the example first computing system 550 and the example second computing system 570 to cause the computing system(s) 550, 570 to train the convolution neural network associated with the UNET architecture. For example, the trainer(s) 558, 578 access training data 554, 574 (block 805). The training data can include existing weights associated with RGB values and/or gradient vector flows of an image. The trainer(s) 558, 578 identify data features represented by the training data 554, 574 (block 810). The training controller(s) 556, 576 instruct the trainer(s) 558, 578 to perform training of the neural network (e.g., a convolutional neural network) using the training data 554, 574 to generate a UNET-based spatial map generation model 564 and/or a UNET-based field map generation model 584 (block 815). In some examples, additional training is performed to refine the models 564, 584 (block 820).

FIG. 9 is a block diagram of an example processing platform 900 structured to execute and/or instantiate the machine readable instructions and/or operations of FIG. 5 to implement the example image segmentor circuitry 110 of FIG. 1. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the includes image data receiver circuitry 505, vector field identifier circuitry 510, spatial feature map generator circuitry 515, field feature map generator circuitry 520, data fusion initiator circuitry 525, and/or segmented image identifier circuitry 530.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output devices 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 932, which may be implemented by the machine readable instructions of FIGS. 6 and/or 8, may be stored in the mass storage device 928, in the volatile memory 914, in the non-volatile memory 916, and/or on a removable non-transitory computer readable storage medium such as a CD or DVD.

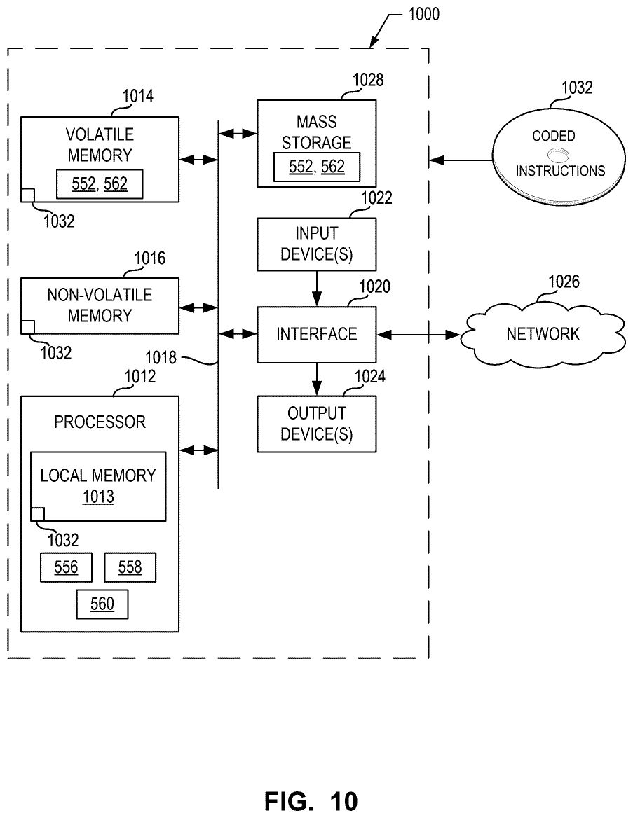

FIG. 10 is a block diagram of an example processing platform including processor circuitry structured to execute the example machine readable instructions and/or the example operations of FIG. 8 to implement the example first computing system 550 of FIG. 5. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example neural network processor 560, the example trainer 558, and the example training controller 556.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1016 may be implemented by flash memory and/or any other desired type of memory device. Access to the main memory 1014, 1016 is controlled by a memory controller.

The processor platform 1000 of the illustrated example also includes an interface circuit 1020. The interface circuit 1020 may be implemented by any type of interface standard, such as an Ethernet interface, a universal serial bus (USB), a Bluetooth® interface, a near field communication (NFC) interface, and/or a PCI express interface.

In the illustrated example, one or more input devices 1022 are connected to the interface circuit 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1020 of the illustrated example, thus, typically includes a graphics driver card, a graphics driver chip and/or a graphics driver processor.

The interface circuit 1020 of the illustrated example also includes a

communication device such as a transmitter, a receiver, a transceiver, a modem, a residential gateway, a wireless access point, and/or a network interface to facilitate exchange of data with external machines (e.g., computing devices of any kind) via a network 1026. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, redundant array of independent disks (RAID) systems, and digital versatile disk (DVD) drives.

The machine executable instructions 1032, which may be implemented by the machine readable instructions of FIG. 8, may be stored in the mass storage device 1028, in the volatile memory 1014, in the non-volatile memory 1016, and/or on a removable non-transitory computer readable storage medium such as a CD or DVD.

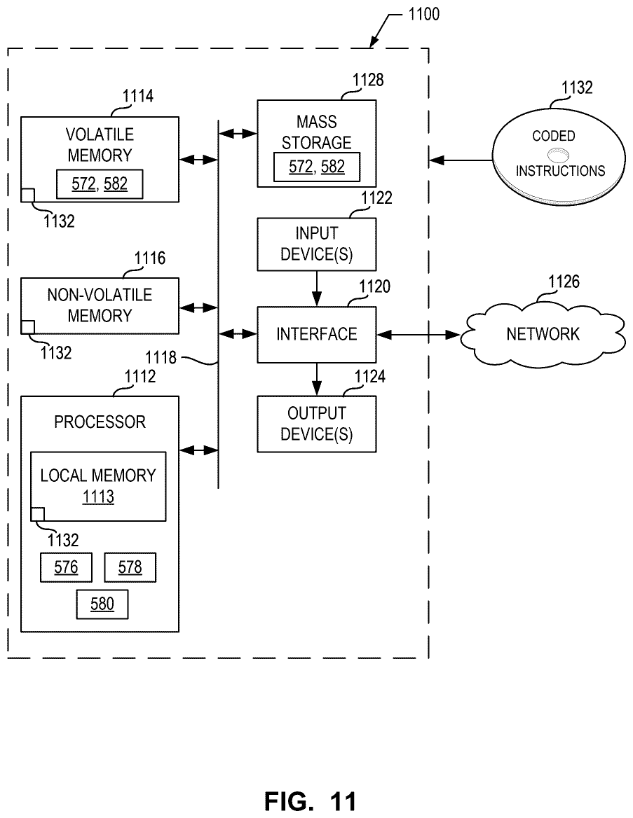

FIG. 11 is a block diagram of an example processing platform including processor circuitry structured to execute the example machine readable instructions and/or the example operations of FIG. 8 to implement the example second computing system 570 of FIG. 5. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example neural network processor 570, the example trainer 578, and the example training controller 576.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132, which may be implemented by the machine readable instructions of FIG. 8, may be stored in the mass storage device 1128, in the volatile memory 1114, in the non-volatile memory 1116, and/or on a removable non-transitory computer readable storage medium such as a CD or DVD.

FIG. 12 is a block diagram 1200 of an example implementation of the processor circuitry 912, 1012, 1112 of FIGS. 9, 10 and/or 11. In this example, the processor circuitry 912, 1012, 1112 of FIGS. 9, 10, 11 is implemented by a microprocessor 1200. For example, the microprocessor 1200 may be a general purpose microprocessor (e.g., general purpose microprocessor circuitry). The microprocessor 1200 executes some or all of the machine readable instructions of the flowchart of FIGS. 6, 7 and/or 8 to effectively instantiate the circuitry of FIGS. 1 and/or 5 as logic circuits to perform the operations corresponding to those machine readable instructions. In some such examples, the circuitry of FIGS. 1 and/or 5 is instantiated by the hardware circuits of the microprocessor 1 200 in combination with the instructions. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 6, 7, and/or 8.

The cores 1202 may communicate by an example bus 1204. In some examples, the bus 1204 may implement a communication bus to effectuate communication associated with one(s) of the cores 1202. For example, the bus 1204 may implement at least one of an Inter-Integrated Circuit (I2C) bus, a Serial Peripheral Interface (SPI) bus, a PCI bus, or a PCIe bus. Additionally or alternatively, the bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 914, 916 of FIG. 9, the main memory 1014, 1016 of FIG. 10, the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and an example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer-based operations. In other examples, the AL circuitry 1216 also performs floating point operations. In yet other examples, the AL circuitry 1216 may include first AL circuitry that performs integer-based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram 1300 of another example implementation of the processor circuitry of FIGS. 9, 10 and/or 11. In this example, the processor circuitry 912, 1012, 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 6, 7 and/or 8 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 6, 7 and/or 8. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 6, 7 and/or 8. As such, the FPGA circuitry 1300 may be structured to effectively instantiate some or all of the machine readable instructions of the flowcharts of FIGS. 6, 7 and/or 8 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 6, 7, and/or 8 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1300 of FIG. 13. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIGS. 6, 7, and/or 8 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 912, 1012, 1112 of FIGS. 9, 10, and/or 11, many other approaches are contemplated. For example, as mentioned above, modern FPGA circuitry may include an on-board CPU, such as one or more of the example CPU 1320 of FIG. 13. Therefore, the processor circuitry 912, 1012, 1112 of FIGS. 9, 10, and/or 11 may additionally be implemented by combining the example microprocessor 1200 of FIG. 12 and the example FPGA circuitry 1300 of FIG. 13. In some such hybrid examples, a first portion of the machine readable instructions represented by the flowchart of FIGS. 6, 7 and/or 8 may be executed by one or more of the cores 1202 of FIG. 12, a second portion of the machine readable instructions represented by the flowcharts of FIGS. 6, 7 and/or 8 may be executed by the FPGA circuitry 1300 of FIG. 13, and/or a third portion of the machine readable instructions represented by the flowcharts of FIGS. 6, 7 and/or 8 may be executed by an ASIC. It should be understood that some or all of the circuitry of FIGS. 9, 10, 11 may, thus, be instantiated at the same or different times. Some or all of the circuitry may be instantiated, for example, in one or more threads executing concurrently and/or in series. Moreover, in some examples, some or all of the circuitry of FIGS. 9, 10, 11 may be implemented within one or more virtual machines and/or containers executing on the microprocessor.

In some examples, the processor circuitry 912, 1012, 1112 of FIGS. 9, 10, 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 912, 1012, 1112 of FIGS. 9, 10, 11 which may be in one or more packages. For example, the XPU may include a CPU in one package, a DSP in another package, a GPU in yet another package, and an FPGA in still yet another package.

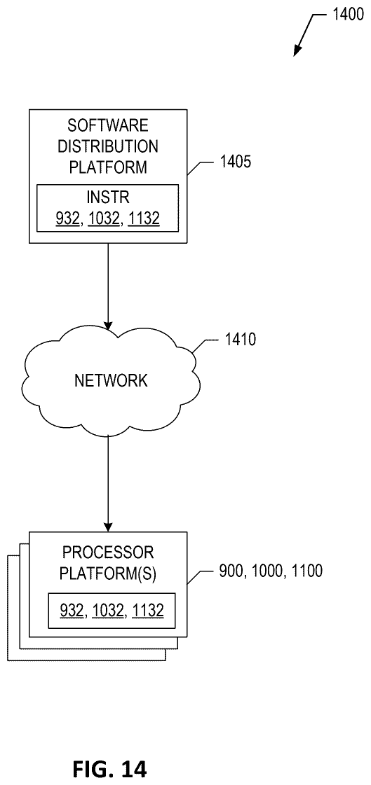

A block diagram illustrating an example software distribution platform 1405 to distribute software such as the example machine readable instructions 932, 1032, 1132 of FIGS. 9, 10 and/or 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 932, 1032, 1132 of FIGS. 9, 10 and/or 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 932, 1032, 1132 of FIGS. 9, 10 and/or 11, which may correspond to the example machine readable instructions 600, 615 and/or 800 of FIGS. 6, 7 and/or 8, as described above. The one or more servers of the example software distribution platform 1405 are in communication with a network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932, 1032, 1132 from the software distribution platform 1405. For example, the software, which may correspond to the example machine readable instructions 600, 615 and/or 800 of FIGS. 6, 7 and/or 8 may be downloaded to the example processor platform 900, 1000, 1100 which is to execute the machine readable instructions 932, 1032, 1132 to implement the image segmentor circuitry 110. In some example, one or more servers of the software distribution platform 1405 periodically offer, transmit, and/or force updates to the software (e.g., the example machine readable instructions 932, 1032, 1132 of FIGS. 9, 10, 11) to ensure improvements, patches, updates, etc., are distributed and applied to the software at the end user devices.

From the foregoing, it will be appreciated that example systems, methods, apparatus, and articles of manufacture have been disclosed that permit image segmentation using small datasets. In particular, methods and apparatus disclosed herein introduce a two-steam network architecture by introducing gradient vector flow (GVF) as part of temporal features associated with an input image. A higher accuracy of image segmentation permits improved assessment of input image(s). Furthermore, methods and apparatus disclosed herein permit a decrease in computational and/or memory demands during image segmentation tasks, also resulting in a decrease in costs associated with the image assessment as compared to the use of existing image segmentation techniques.

Example methods, apparatus, systems, and articles of manufacture to perform image segmentation on small dataset are disclosed herein. Further examples and combinations thereof include the following:

Example 1 includes an apparatus, comprising at least one memory, machine readable instructions, and processor circuitry to at least one of instantiate or execute the machine readable instructions to identify a gradient vector flow associated with an input image, generate a spatial feature map based on pixels of the input image using a two-stream neural network architecture, generate a field feature map based on the gradient vector flow using the two-stream neural network architecture, fuse the spatial feature map and the field feature map, and output a segmented image of the input image based on the fused feature map.

Example 2 includes the apparatus of example 1, wherein the two-stream neural network architecture is a UNET architecture, the UNET architecture an encode-decode convolutional neural network (CNN) model.

Example 3 includes the apparatus of example 2, wherein the UNET architecture includes a spatial stream and a temporal stream.

Example 4 includes the apparatus of example 1, wherein the processor circuitry is to train the neural network to determine weights associated with RGB values of the input image as part of generating the spatial feature map.

Example 5 includes the apparatus of example 1, wherein the processor circuitry is to train the neural network to determine weights associated with the gradient vector flow of the input image as part of generating the field feature map.

Example 6 includes the apparatus of example 1, wherein the processor circuitry is to fuse the spatial feature map and the field feature map using at least one of a sum fusion, a matrix fusion, a concatenation fusion, and a convolution fusion.

Example 7 includes the apparatus of example 1, wherein the segmented image of the input image is a predicted mask, the predicted mask to identify a prediction accuracy of the two-stream neural network.

Example 8 includes a method, comprising identifying a gradient vector flow associated with an input image, generating a spatial feature map based on pixels of the input image using a two-stream neural network architecture, generating a field feature map based on the gradient vector flow using the two-stream neural network architecture, fusing the spatial feature map and the field feature map, and outputting a segmented image of the input image based on the fused feature map.

Example 9 includes the method of example 8, wherein the two-stream neural network architecture is a UNET architecture, the UNET architecture an encode-decode convolutional neural network (CNN) model.

Example 10 includes the method of example 9, wherein the UNET architecture includes a spatial stream and a temporal stream.

Example 11 includes the method of example 8, further including training the neural network to determine weights associated with RGB values of the input image as part of generating the spatial feature map.

Example 12 includes the method of example 8, further including training the neural network to determine weights associated with the gradient vector flow of the input image as part of generating the field feature map.

Example 13 includes the method of example 8, further including fusing the spatial feature map and the field feature map using at least one of a sum fusion, a matrix fusion, a concatenation fusion, and a convolution fusion.

Example 14 includes the method of example 8, wherein the segmented image of the input image is a predicted mask, the predicted mask to identify a prediction accuracy of the two-stream neural network.

Example 15 includes a non-transitory machine readable storage medium comprising instructions that, when executed, cause processor circuitry to at least identify a gradient vector flow associated with an input image, generate a spatial feature map based on pixels of the input image using a two-stream neural network architecture, generate a field feature map based on the gradient vector flow using the two-stream neural network architecture, fuse the spatial feature map and the field feature map, and output a segmented image of the input image based on the fused feature map.

Example 16 includes the non-transitory machine readable storage medium of example 15, wherein the two-stream neural network architecture is a UNET architecture, the UNET architecture an encode-decode convolutional neural network (CNN) model.

Example 17 includes the non-transitory machine readable storage medium of example 16, wherein the UNET architecture includes a spatial stream and a temporal stream.

Example 18 includes the non-transitory machine readable storage medium of example 15, wherein the instructions, when executed, cause the processor circuitry to train the neural network to determine weights associated with RGB values of the input image as part of generating the spatial feature map.

Example 19 includes the non-transitory machine readable storage medium of example 15, wherein the instructions, when executed, cause the processor circuitry to train the neural network to determine weights associated with the gradient vector flow of the input image as part of generating the field feature map.

Example 20 includes the non-transitory machine readable storage medium of example 15, wherein the instructions, when executed, cause the processor circuitry to fuse the spatial feature map and the field feature map using at least one of a sum fusion, a matrix fusion, a concatenation fusion, and a convolution fusion.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus, comprising:
interface circuitry;
machine readable instructions; and
at least one processor circuit to be programmed by the machine readable instructions to:
identify a gradient vector flow associated with an input image;
generate a spatial feature map based on pixels of the input image using a two-stream neural network architecture;
generate a field feature map based on the gradient vector flow using the two-stream neural network architecture;
fuse the spatial feature map and the field feature map; and
output a segmented image of the input image based on the fused feature map.

2. The apparatus of claim 1, wherein the two-stream neural network architecture is a UNET architecture, the UNET architecture an encode-decode convolutional neural network (CNN) model.

3. The apparatus of claim 2, wherein the UNET architecture includes a spatial stream and a temporal stream.

4. The apparatus of claim 1, wherein one or more of the at least one processor circuit is to train the neural network to determine weights associated with RGB values of the input image as part of generating the spatial feature map.

5. The apparatus of claim 1, wherein one or more of the at least one processor circuit is to train the neural network to determine weights associated with the gradient vector flow of the input image as part of generating the field feature map.

6. The apparatus of claim 1, wherein one or more of the at least one processor circuit is to fuse the spatial feature map and the field feature map using at least one of a sum fusion, a matrix fusion, a concatenation fusion, and a convolution fusion.

7. The apparatus of claim 1, wherein the segmented image of the input image is a predicted mask, the predicted mask to identify a prediction accuracy of the two-stream neural network.

8-14. (canceled)

15. At least one non-transitory machine readable medium comprising machine readable instructions to cause at least one processor circuit to at least:
identify a gradient vector flow associated with an input image;
generate a spatial feature map based on pixels of the input image using a two-stream neural network architecture;
generate a field feature map based on the gradient vector flow using the two-stream neural network architecture;
fuse the spatial feature map and the field feature map; and
output a segmented image of the input image based on the fused feature map.

16. The at least one non-transitory machine readable medium of claim 15, wherein the two-stream neural network architecture is a UNET architecture, the UNET architecture an encode-decode convolutional neural network (CNN) model.

17. The at least one non-transitory machine readable medium of claim 16, wherein the UNET architecture includes a spatial stream and a temporal stream.

18. The at least one non-transitory machine readable medium of claim 15, wherein the machine readable instructions are to cause one or more of the at least one processor circuit to train the neural network to determine weights associated with RGB values of the input image as part of generating the spatial feature map.

19. The at least one non-transitory machine readable medium of claim 15, wherein the machine readable instructions are to cause one or more of the at least one processor circuit to train the neural network to determine weights associated with the gradient vector flow of the input image as part of generating the field feature map.

20. The at least one non-transitory machine readable medium of claim 15, wherein the machine readable instructions are to cause one or more of the at least one processor circuit to fuse the spatial feature map and the field feature map using at least one of a sum fusion, a matrix fusion, a concatenation fusion, and a convolution fusion.

21. An apparatus, comprising:
means for identifying a gradient vector flow associated with an input image;
means for generating a spatial feature map based on pixels of the input image using a two-stream neural network architecture;
means for generating a field feature map based on the gradient vector flow using the two-stream neural network architecture;
means for fusing the spatial feature map and the field feature map; and
means for outputting a segmented image of the input image based on the fused feature map.

22. The apparatus of claim 21, wherein the two-stream neural network architecture is a UNET architecture, the UNET architecture an encode-decode convolutional neural network (CNN) model.

23. The apparatus of claim 22, wherein the UNET architecture includes a spatial stream and a temporal stream.

24. The apparatus of claim 21, the means for generating a spatial feature map including training the neural network to determine weights associated with RGB values of the input image as part of generating the spatial feature map.

25. The apparatus of claim 21, the means for generating a field feature map including training the neural network to determine weights associated with the gradient vector flow of the input image as part of generating the field feature map.

26. The apparatus of claim 21, the means for fusing including fusing the spatial feature map and the field feature map using at least one of a sum fusion, a matrix fusion, a concatenation fusion, and a convolution fusion.

27. The apparatus of claim 21, wherein the segmented image of the input image is a predicted mask, the predicted mask to identify a prediction accuracy of the two-stream neural network.
